(19) United States
(12) Patent Application Publication
(10) Pub. No.: US 2023/0278529 A1
(43) Pub. Date: Sep. 7, 2023

(54) Cleaning device, vehicle and method for operating a cleaning device

(71) Applicant: ZF CV Systems Global GmbH, Bern (CH)

(72) Inventor: Janik Ricke, Uetze (DE)

(21) Appl. No.: 18/305,104

(22) Filed: Apr. 21, 2023

Related U.S. Application Data
(63) Continuation of application No. PCT/EP2021/076442, filed on Sep. 27, 2021.

(30) Foreign Application Priority Data
Oct. 26, 2020 (DE) 10 2020 128 100.5

(51) Int. Cl. B60S 1/52; B60S 1/54; B60S 1/56

(52) U.S. Cl. CPC B60S 1/52; B60S 1/54; B60S 1/56

(57) ABSTRACT

A cleaning device for a vehicle provides a liquid cleaning pulse and/or a compressed-air cleaning pulse for at least one cleaning nozzle. The device has a cylinder and a separator that divides the cylinder volume in fluid-tight fashion into an air chamber and a liquid chamber. The separator is movable along a cylinder axis and bears sealingly against an internal wall of the cylinder. The air chamber has a port for admitting compressed air with a charge pressure for filling the chamber. The charge pressure acts on an air action surface of the separator to generate a displacement force on a liquid action surface, facing toward the liquid chamber, of the separator to generate a liquid pressure of the cleaning liquid in the liquid chamber. The cylinder is configured as a pressure booster. The liquid action surface is smaller than the air action surface facing toward the same.

### CROSS-REFERENCE TO RELATED APPLICATIONS

This application is a continuation application of international patent application PCT/EP2021/076442, filed Sep. 27, 2021, designating the United States and claiming priority from German application 10 2020 128 100.5, filed Oct. 26, 2020, and the entire content of both applications is incorporated herein by reference.

### TECHNICAL FIELD

The disclosure relates to a cleaning device.

### BACKGROUND

Cleaning devices, in particular for a vehicle for providing a liquid cleaning pulse and/or a compressed-air cleaning pulse, are generally known. Such cleaning devices are used in particular to clean sensors, for example surfaces of camera lenses or other optical sensors, in order to ensure the functioning thereof during the operation of a vehicle. For cleaning devices of the type in question, there is typically a conflict of aims between different performance features, in particular adequate cleaning performance and/or low liquid consumption and/or low expenditure on apparatus.

Against this background, there are for example approaches for saving liquid during the cleaning operation. For example, US 2017/0168291 presents a camera unit for imaging an exterior region for a motor vehicle with a cleaning device provided for cleaning the camera unit, wherein the cleaning device includes an actuator for driving a movable component, in particular a piston. The cleaning device presented in US 2017/0168291 includes a housing, wherein the housing includes two chambers, wherein a first chamber has a greater fill volume than a second chamber.

Such an approach, which is advantageous in principle, duly already takes into consideration the fact that different quantities of air and water can be used for cleaning purposes by virtue of air and water being held in chambers of different size and being conveyed via a commonly driven component, but only in order to reduce water consumption.

The expenditure on apparatus, in particular the fact that, for each cleaning device, a separate actuator in the form of a drive is required for conveying air and water, are however still problematic. The fact that it is still inadequately possible to set a liquid pressure of the cleaning liquid is also a problem. It would therefore be desirable to at least partially alleviate one of the stated problems. In particular, the least possible expenditure on apparatus, and/or a small structural space, would be desirable. Also, in order to achieve the greatest possible cleaning performance, an improved ability to set a relatively high liquid pressure would be desirable, in particular in relation to a charge pressure of the compressed air that is available or provided in the vehicle.

### SUMMARY

It is an object of the disclosure to provide an improved specification of a cleaning device which in particular reduces the expenditure on apparatus and/or makes it possible for an in particular relatively high liquid pressure to be set.

The object relating to the cleaning device is achieved via the disclosure, in a first aspect, via a cleaning device. The disclosure is based on a cleaning device for a vehicle for providing a liquid cleaning pulse and/or a compressed-air cleaning pulse for at least one cleaning nozzle, the cleaning device having:
a pressure cylinder with a cylinder volume, having a movable separator that divides the cylinder volume in fluid-tight fashion into a first air chamber, which receives an air quantity, and a second liquid chamber, which receives a liquid quantity, wherein the separator is movable axially along a cylinder axis and bears sealingly against a cylinder internal wall of the pressure cylinder.

According to the disclosure, in the cleaning device, provision is made whereby
the air chamber has at least one air chamber port configured to admit compressed air with a charge pressure for filling the air chamber, wherein, when the air chamber is filled with the air quantity, the charge pressure acts on an air action surface, facing toward the air chamber, of the separator in order to generate a displacement force, wherein the displacement force acts on a liquid action surface, facing toward the liquid chamber, of the separator in order to generate a liquid pressure of the cleaning liquid that is received in the liquid chamber, and
the pressure cylinder is configured as a pressure booster, wherein the liquid action surface is smaller than the air action surface facing toward same, such that the liquid pressure is higher than the charge pressure.

It can preferable be for at least one first and at least one second chamber to be provided, that is, it is also possible in principle for multiple air chambers and/or multiple liquid chambers to be provided, wherein, in that case, too, the pressure cylinder is configured as a pressure booster, that is, in the case of each air chamber and associated liquid chamber, the liquid action surface is smaller than the air action surface facing toward same, such that the liquid pressure is higher than the charge pressure. It may also be the case overall, that is, cumulatively for the multiple chambers, that the liquid action surface is smaller than the air action surface facing toward same, such that the liquid pressure is higher than the charge pressure.

The pressure cylinder is thus actuatable using compressed air. In particular, the separator has a first air action surface, facing toward the air chamber, and a second liquid action surface, facing toward the liquid chamber, wherein the liquid action surface is arranged opposite the air action surface in the direction of the cylinder axis and is in particular rigidly connected thereto. When the air chamber is enlarged, the liquid chamber is reduced in size. Here, cleaning liquid is provided in the form of the liquid cleaning pulse, with a liquid pressure, via a liquid chamber port of the liquid chamber.

The disclosure is based on the recognition that a compressed-air supply system, and/or a compressed-air source, is generally available in vehicles. This is the case in particular owing to other vehicle functions, for example an air suspension system, a brake system or the like. Owing to this availability of compressed air, the compressed air can advantageously also be used in a cleaning device, both as a medium and as an energy source. When using compressed air as an energy source, there is also the advantage that one compressed-air source can be used to provide a supply to multiple cleaning devices, in particular when taking into account solutions from the prior art, in which a separate actuator is provided for each cleaning device.

Through the use of a compressed-air source that is in particular already present in the vehicle, the dependency on any actuating drives for the cleaning device, in particular for the purposes of generating cleaning pulses, can advantageously be reduced, or such actuating drives can even be omitted entirely.

The disclosure has surprisingly identified that a liquid cleaning pulse with a relatively high liquid pressure is advantageous, but even a relatively small liquid quantity is adequate, for effective cleaning, in particular of a sensor surface. At the same time, conversely, a compressed-air cleaning pulse with a relatively low pulse pressure is adequate, but a relatively large air quantity, or a compressed-air cleaning pulse of longer duration, is advantageous.

These relationships can advantageously be utilized with a cleaning device according to the disclosure, having a pressure cylinder that functions as a pressure booster. By virtue of the fact that the liquid action surface is smaller than the air action surface facing toward same, the liquid pressure can be set in a manner dependent on the ratio between the liquid action surface and the air action surface, specifically such that the liquid pressure is higher than the charge pressure.

In an embodiment, provision is made whereby the separator is held in the pressure cylinder via a restoring spring for generating a restoring force that acts counter to the displacement force, in particular when the separator is moved while the air chamber is being filled, in particular in order for the separator to be moved back by the restoring force for the purposes of providing an air quantity as a compressed-air cleaning pulse and/or for the purposes of refilling the liquid chamber with cleaning liquid. In such an embodiment, the restoring spring may advantageously be implemented as a mechanical energy store by which the separator can be moved back into its initial position. In particular, it is advantageously possible to omit an additional conveying device or an additional actuator for moving the separator back, in particular for conveying the cleaning liquid.

The disclosure can be refined by the fact that:
the separator has a first air action surface and a second air action surface that is arranged opposite the first air action surface in the direction of the cylinder axis, and
the separator has a first liquid action surface that is arranged opposite the first air action surface in the direction of the cylinder axis, and
the separator has a second liquid action surface that is arranged opposite the second air action surface in the direction of the cylinder axis, wherein the first air action surface faces toward a first air chamber, the second air action surface faces toward a second air chamber, the first liquid action surface faces toward a first liquid chamber, and the second liquid action surface faces toward a second liquid chamber. In such an embodiment, the separator is preferably configured as a multiple plunger, in particular as a symmetrical multiple plunger. In particular, the multiple plunger has an air plunger and has liquid plungers, in particular a first liquid plunger and a second liquid plunger, which are spaced apart axially in both directions in the direction of the cylinder axis and which are rigidly connected via a plunger shank. In such an embodiment, it is possible in particular for a supply to be provided to multiple cleaning nozzles and/or multiple nozzle ports via a first and a second cleaning section. In such an embodiment, the pressure cylinder may have at least one restoring spring, in particular two restoring springs which are preferably of the same dimensions and arranged symmetrically. The restoring spring is preferably arranged in the respective air chamber.

In an embodiment, a switching valve is provided, which is configured to produce a pneumatic connection between a module compressed-air port and the air chamber port when in an air admission position, and in particular to produce a pneumatic connection between the air chamber port and a compressed-air nozzle line when in a ventilation position. The switching valve is preferably configured as a 3/2 directional valve, particularly preferably as a 3/2 directional solenoid valve. In embodiments, the switching valve may be configured as a valve that opens in continuously variable fashion, in particular as a valve that is actuatable in continuously variable fashion by way of a pulse-width-modulated signal, in order to allow a charge pressure to be selectively set.

The disclosure can be refined by including a bypass valve arrangement that is configured to produce a pneumatic connection between the module compressed-air port and the compressed-air nozzle line, bypassing the switching valve, when in an open position in order to provide a bypass compressed-air flow. In particular, the bypass valve arrangement has a compressed-air pulse check valve and/or a 2/2 directional valve. The 2/2 directional valve is formed in particular as a 2/2 directional solenoid valve. Via a bypass valve arrangement, a compressed-air flow for a cleaning nozzle can advantageously be provided independently of the pressure cylinder.

In an embodiment, provision is made whereby the pressure cylinder and/or the separator are configured such that the air chamber has a dead volume through which the separator does not pass, wherein the air chamber port is arranged in the region of the dead volume. In particular, the dead volume has an axial extent of less than 5 mm, preferably less than 2 mm. Via a dead volume, it is advantageously ensured that an air action surface of the can via does not bear directly against other parts of the pressure cylinder. In this way, it is ensured that the compressed air flowing in via the air chamber port can always come into contact with the air action surface and thus, in particular, the charge pressure can act on the air action surface for the purposes of actuating the separator.

The disclosure is refined by the fact that the separator is configured as a multiple plunger, wherein at least one air plunger is connected via a plunger shank to at least one liquid plunger. The liquid plunger has at least one liquid action surface. The air plunger has at least one air action surface. A structural form of the separator as a multiple plunger is advantageous because it makes it possible for the air and liquid action surfaces to be fixedly, in particular rigidly, spaced apart in a relatively material-saving and weight-saving manner.

A charge pressure is in particular less than 10 bar, preferably between 3 and 7 bar, and is particularly preferably 5 bar. A liquid plunger diameter is in particular 15 mm. An air plunger diameter is in particular 20 mm.

In an embodiment, a charge pressure setter is provided, in particular a pressure control valve and/or a proportional valve, wherein the charge pressure setter is arranged in particular in the compressed-air connection line. A charge pressure can advantageously be set, for example to be permanently constant or selectively variable, using a charge pressure setter. In particular, the cleaning device and/or the charge pressure setter may be configured to set the charge pressure in a manner dependent on a cleaning check signal. In this way, it is for example advantageously possible, in the presence of relatively large and/or stubborn soil deposits, for a relatively high charge pressure to be set, which results in particular in a relatively high pulse pressure and/or relatively high liquid pressure.

The disclosure is refined by including at least one cleaning nozzle that is arranged and configured for applying a liquid cleaning pulse and/or a compressed-air cleaning pulse to at least one sensor surface.

In a second aspect, the disclosure specifies a vehicle, in particular a passenger motor vehicle or a utility vehicle or a trailer, having at least one cleaning device according to the first aspect of the disclosure. The advantages of the cleaning device according to the first aspect are advantageously utilized in the vehicle according to the second aspect of the disclosure.

### BRIEF DESCRIPTION OF DRAWINGS

The invention will now be described with reference to the drawings wherein:

FIG. 1 shows a first embodiment of a cleaning device according to the concept of the disclosure;

FIG. 2 shows a further embodiment of a cleaning device according to the concept of the disclosure; and,

FIG. 3 is a schematic illustration of a vehicle having a cleaning device according to the concept of the disclosure.

### DETAILED DESCRIPTION

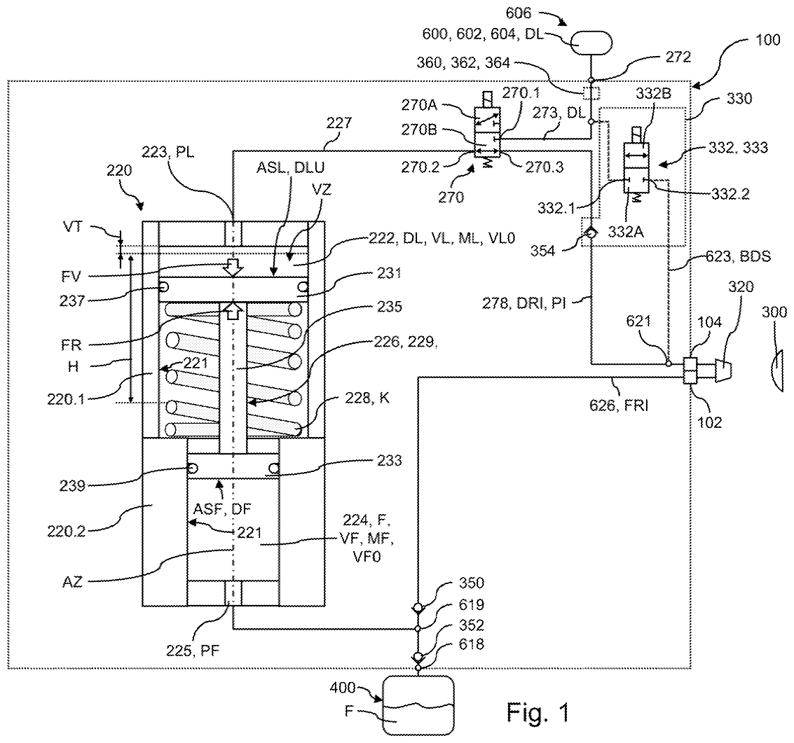

FIG. 1 shows a first embodiment of a cleaning device 100 according to the concept of the disclosure. The cleaning device 100 is configured to provide compressed air DL in the form of a compressed-air cleaning pulse DRI at a nozzle compressed-air port 104 and to provide cleaning liquid F in the form of a liquid cleaning pulse FRI at a nozzle liquid port 102. The cleaning device 100 has a module compressed-air port 272 that is configured to admit compressed air DL from a compressed-air source 600, in particular a compressor 602 and/or a pressure accumulator 604 of a compressed-air supply system 606. The module compressed-air port 272 is pneumatically connected via a compressed-air connection line 273 to a first port 270.1 of a switching valve 270. The switching valve 270 is configured here as a 3/2 directional solenoid valve. The cleaning device 100 has a module liquid port 618 that is configured to admit cleaning liquid F from a liquid source 400.

The cleaning device 100 has a pressure cylinder 220 that can be pressurized with compressed air DL at an air chamber port 223.

The pressure cylinder 220 has a separator/divider 226 which is configured as a multiple plunger 229 and which is movable axially along a cylinder axis AZ and which variably divides a cylinder volume VZ of the pressure cylinder 220 into at least one air chamber 222 and one liquid chamber 224.

The pressure cylinder 220 has, in the region of the air chamber 222, an air chamber port 223 via which the air chamber 222 can be pressurized with compressed air DL in order to fill the air chamber 222. The compressed air DL that is provided at the air chamber port 223 is in particular at a charge pressure PL. The charge pressure PL is set in particular by the pressure source 600 or optionally by a suitable pneumatic charge pressure setter 360, in particular a pressure control valve 362 or a proportional valve 364. For this purpose, the cleaning device 101 may have such charge pressure setter 360, arranged in particular in the compressed-air connection line 273.

When the air chamber port 223 is pressurized, in particular with a charge pressure PL, the charge pressure PL of the compressed air DL, in particular air quantity ML, entering the air chamber 222 acts on an air action surface ASL, facing toward the air chamber 222, of the separator 226. The charge pressure PL acting on the air action surface ASL results in a displacement force FV acting on the separator 226. The air chamber 222 is expanded, with the separator 226 being displaced, wherein the liquid chamber 224 decreases in size at the same time, and the liquid quantity MF of cleaning liquid F that is held in the liquid chamber 224 is provided as a liquid cleaning pulse FRI at the liquid chamber port 225.

In the present case, the separator 226 is held in the pressure cylinder 220 by a restoring spring 228, whereby, when the separator 226 is deflected, the restoring spring 228 generates a restoring force FR that opposes the displacement force FV. The restoring force FR is in particular dependent on a spring constant K of the restoring spring 228. The air chamber port 223 is pneumatically connected via an air chamber line 227 to a second port 270.2 of the switching valve 270. The higher the spring constant K, the greater the restoring force FR. The greater the restoring force FR, the greater the pulse pressure PI. At the same time, however, the liquid pressure PF decreases, because the restoring force FR acts counter to the displacement force FV.

The separator 226 is received in the pressure cylinder 220 so as to be axially movable through a stroke H. In particular, in the air chamber 222, a dead volume VT may be provided through which the separator 226, in particular the air plunger 231, does not pass. This means that the separator 226, when it reaches its axial end position, stops short of an end-side wall of the pressure cylinder 220. Via a dead volume VT, it is advantageously ensured that the compressed air entering the air chamber 222 via the air chamber port 223 comes into contact with the entire air action surface ASL, and the charge pressure PL can therefore act on the entire air action surface ASL. The air chamber port 223 is advantageously arranged in the region of the dead volume VT, in particular in the end-side wall of the pressure cylinder 220 and/or in the air-chamber barrel segment 220.1 of the pressure cylinder 220, specifically in the region of the dead volume VT.

In the region of the liquid chamber 224, the pressure cylinder 220 has a liquid chamber port 225 via which the liquid chamber 224 is connected in fluid-conducting fashion to a liquid nozzle line 626. The liquid chamber port 225 is connected in fluid-conducting fashion to the liquid nozzle line 626 at a cylinder connection point 619. When the air chamber port 223 is pressurized with compressed air DL and the separator 226 is displaced, a liquid quantity MF that is held in the liquid chamber 224 is provided in the form of a liquid cleaning pulse FRI via the liquid chamber port 225, and via the cylinder connection point 619 and the liquid nozzle line 626, at the nozzle liquid port 102 for a cleaning nozzle 320. This occurs by virtue of the volume of the liquid chamber 224 being reduced in size as a result of the displacement of the separator 226, and the cleaning liquid F thus being forced, in particular in the form of a pulse, out of the pressure cylinder 220.

The separator 226 is in the form of a multiple plunger 229, with an air plunger 231 and a liquid plunger 233 that are rigidly connected to one another via a plunger shank 235. The air plunger 231 is arranged in an air chamber portion 220.1 of the pressure cylinder 220 and has an air active surface ASL that faces toward the air chamber 224. The liquid plunger 233 is arranged in a liquid chamber segment 220.2 of the pressure cylinder 220 and has a liquid active surface ASF that faces toward the liquid chamber 224. The air chamber portion 220.1 and the liquid chamber segment 220.2 each have an internal diameter that corresponds to the external diameter or the action surface ASL, ASF of the respective plunger 231, 233, so as to produce axially movable but fluid-tight contact. The separator 226 is movable axially along the cylinder axis AZ within the cylinder volume VZ of the pressure cylinder 220. The air plunger 231 and the liquid plunger 233 are configured so as to each bear in pressure-tight fashion against a cylinder internal wall 221 of the pressure cylinder 220.

Optionally, in order to better seal off the air chamber 222 with respect to the liquid chamber 224, the separator 226 may have one or more sealing rings, composed in particular of plastics and/or rubber. In the present case, the air plunger 231 has an air plunger sealing ring 237 arranged in a circumferential direction, and the liquid plunger 233 has a liquid plunger sealing ring 239.

The separator 226 divides the cylinder volume VZ into an air chamber 222 and a liquid chamber 224 in a variable manner. Owing to the action surfaces ASL, ASF that are rigidly connected and of different size, an effective air chamber volume VL0 that exists in the air chamber 222 when the separator 226 has been deflected by a maximum stroke H is larger than an effective liquid chamber volume VF0 that exists in the liquid chamber 224 when the separator 226 has been deflected by a maximum stroke H in the opposite direction.

The multiple plunger 229 is held in the cylinder volume VZ of the pressure cylinder 220 by a restoring spring 228 such that, in the event of a deflection, caused in particular by a pressurization of the air chamber port 223 with the charge pressure PL, a restoring force FR is generated.

Via an air chamber port 223, the air chamber 222 can, on the one hand, be pressurized with compressed air DL at a charge pressure PL in order to generate a displacement force FV that acts on the air action surface ASL of the separator 226. On the other hand, for the purposes of providing a compressed-air cleaning pulse DRI, compressed air DL can be discharged, at a pulse pressure PI, via the air chamber port 223 by the separator 226 that moves back, in particular owing to the restoring force FR. Here, the pulse pressure PI is determined in particular by dividing the restoring force FR by the area of the air action surface ASL. In embodiments with a restoring spring, the liquid pressure PF is determined in particular by dividing the difference between the displacement force FV and the restoring force FR by the area of the liquid action surface ASF.

Via a liquid chamber port 225, the liquid chamber 224 can draw in cleaning liquid F and can discharge same at a liquid pressure PF for the purposes of providing a liquid cleaning pulse FRI. The liquid pressure PF is dependent on the charge pressure PL, but it is not possible for the entire charge pressure PL to be utilized as liquid pressure PF at the liquid chamber port 225, because losses arise in overcoming the restoring force FR.

A liquid plunger diameter DF of the liquid plunger 233 (with correspondingly resulting circular liquid action surface ASF) of 15 mm and a stroke of 19 mm result in an effective liquid chamber volume VF0 of 3.4 ml. An air plunger diameter DLU of the liquid plunger 231 (with correspondingly resulting circular air action surface ASL) of 20 mm and the stroke of 19 mm result in an effective air chamber volume VL0 of 6.0 ml.

By virtue of the fact that the air action surface ASL is larger than the liquid action surface ASF, the pressure cylinder 220 functions as a pressure booster. The relationship here is substantially as follows—in particular if, for the sake of simplicity, one disregards a pressure loss arising owing to a restoring spring 228:

PL*ASL=PF*ASF

This advantageously results in a liquid pressure PF of 8.9 bar in the case of a charge pressure PL of 5 bar. The liquid pressure PF is actually lower owing to the restoring force FR of a restoring spring 228, which acts counter to the displacement force FV. In the case of a pressure cylinder 220 with a restoring spring 228, the relationship resulting from force equilibrium is as follows:

PL*ASL−FR=PF*ASF

The nozzle compressed-air port 104 is pneumatically connected via the compressed-air nozzle line 278 to a third port 270.3 of the switching valve 270. In particular, the switching valve 270 has a relatively large nominal diameter in order to advantageously transfer the compressed-air cleaning pulse DRI to the compressed-air nozzle line 278 with no pressure losses, or with only the least possible pressure losses. In particular, the switching valve 270 has a nominal diameter that is greater than or equal to the diameter of the compressed-air nozzle line 278 and/or the air chamber line 227. In the present case, but also in general irrespective of the specific embodiment, it has been found that the relatively large nominal diameter of a switching valve 270 in this respect preferably lies in a range above 1.2 mm, in particular in a range from 1.0 mm to 3.0 mm; in general, nominal diameters of a switching valve of the same configuration as or of a similar configuration to the switching valve 270 have proven to be advantageous in order to transfer an air pulse out of the valve piston of the switching valve 270 as effectively as possible. In particular, such nominal widths have proven to be advantageous for cleaning a camera sensor, but are not limited thereto.

An intake pressure check valve 350 is arranged in the liquid nozzle line 626 between the cylinder connection point 619 and the nozzle liquid port 102.

A liquid pulse check valve 352 is arranged in the liquid nozzle line 626 between the cylinder connection point 619 and the module liquid port 618. The liquid pulse check valve 352 prevents cleaning liquid F from escaping in the direction of the module liquid port 618 when the liquid cleaning pulse FRI is provided.

When the switching valve 270 is in an air admission position 270A, the first port 270.1 is pneumatically connected to the second port 270.2, and the third port 270.3 is shut off. In this air admission position 270A, an air pressure prevailing at the module compressed-air port 272, in particular a charge pressure PL, is transferred to the air chamber port 223, resulting in an expansion of the air chamber 222 and the provision of a liquid cleaning pulse FRI at the nozzle liquid port 102. Consequently, the liquid cleaning pulse FRI is applied to a sensor surface 300 via the cleaning nozzle 320.

When the switching valve 270 is in a ventilation position 270B, as illustrated here, the second port 270.2 is pneumatically connected to the third port 270.3, and the first port 270.1 is shut off. This ventilation position 270B results in the air chamber port 223 being ventilated, whereby the separator 226 moves back, in particular owing to the restoring force FR, with the air chamber 222 decreasing in size and the liquid chamber 224 increasing in size. As a result of the separator 226 moving back, a negative pressure is generated at the liquid chamber port 225. Owing to the intake pressure check valve 350, the negative pressure acts only at the module liquid port 618 (and not at the nozzle liquid port 102), whereby new cleaning liquid F is drawn into the liquid chamber 224 from the liquid source 400, in particular without the need for a pump or similar conveying device for the cleaning liquid F.

At the same time, as a result of the separator 226 moving back, a positive pressure is generated at the air chamber port 223, resulting in a flow of compressed air DL via the second port 270.2 and the third port 270.3 to the nozzle compressed-air port 104, whereby a compressed-air cleaning pulse DRI is provided at the nozzle compressed-air port 104. Consequently, the compressed-air cleaning pulse DRI is applied to the sensor surface 300 via the cleaning nozzle 320 for cleaning purposes.

The cleaning operation is thus complete and can be repeated as required, in particular by virtue of the switching valve 270 being switched back into the air admission position 270A.

In advantageous embodiments, the cleaning device 100 may optionally have a bypass valve arrangement 330, as shown here. In particular, the bypass valve arrangement 330 has a compressed-air pulse check valve 354 and a 2/2 directional valve 332. The 2/2 directional valve 332 is formed in particular as a 2/2 directional solenoid valve 333.

The 2/2 directional valve 332 is pneumatically connected via a first port 332.1 to the compressed-air connection line 273, and via a second port 332.2 and a bypass line 623 to a bypass connection point 621 of the compressed-air nozzle line 278.

The compressed-air pulse check valve 354 is in the present case arranged in the compressed-air nozzle line 278 between the third port 270.3 of the switching valve 270 and the bypass connection point 621. The compressed-air pulse check valve 354 is in particular configured to open in a flow direction of the compressed-air cleaning pulse DRI and/or of the bypass compressed-air flow BDS and to close in the opposite direction.

When the 2/2 directional valve 332 is in a closed position 332A, the first port 332.1 is pneumatically separated from the second port 332.2. By virtue of the bypass valve arrangement 330 being switched, the nozzle compressed-air port 104 can be supplied with compressed air DL directly from the module compressed-air or 272, bypassing the switching valve 270. In the present case, this takes place by virtue of the 2/2 directional valve 332 being switched into an open position 332B in which the first port 332.1 is pneumatically connected to the second port 332.2. In this way, the compressed air DL prevailing at the module compressed-air port 272 can be conducted directly via the bypass connection point 621 and the compressed-air nozzle line 278 in order to provide a bypass compressed-air flow BDS at the nozzle compressed-air port 104. Via the bypass valve arrangement 330, it is thus advantageously made possible for compressed air DL, in particular a bypass compressed-air flow BDS, to be applied to the sensor surface 330 without the need to actuate the pressure cylinder 220.

In particular, the compressed-air pulse check valve 354 ensures that, when the 2/2 directional valve 332 is in the open position 332B and the switching valve is in the ventilation position 270B, the compressed air DL cannot flow in the direction of the switching valve 270 and thus into the air chamber 222 of the pressure cylinder 220.

Optionally, the cleaning device 100 may have a charge-pressure setter 360, in particular a pressure control valve 362 and/or a proportional valve 364, in order to set a charge pressure PL. Such a charge-pressure setter 360 may advantageously be arranged in the compressed-air connection line 273. Alternatively or in addition, the switching valve 270 may be configured as a valve that opens in continuously variable fashion, in particular as a valve that is actuatable in continuously variable fashion by way of a pulse-width-modulated signal, in order to allow a charge pressure to be set.

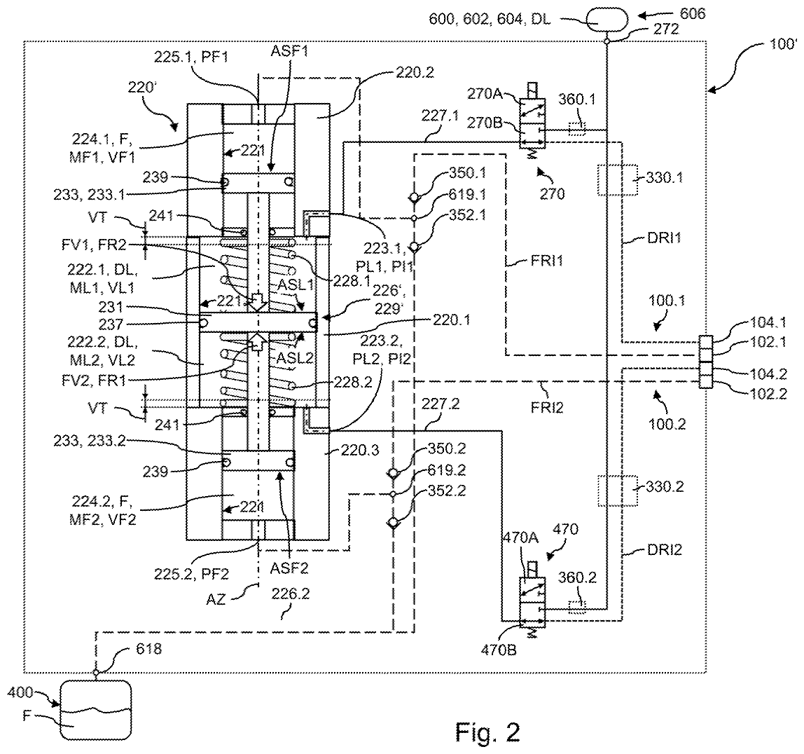

FIG. 2 shows a further embodiment of a cleaning device 100′ according to the concept of the disclosure. The cleaning device 100′ has a pressure cylinder 220′ which, by contrast to the embodiment shown in FIG. 1, has in particular a first chamber 222.1 and a second air chamber 222.2, and a first liquid chamber 224.1 and a second liquid chamber 224.2. That is, in the present case, provision is made in the second embodiment whereby multiple air chambers and/or multiple liquid chambers are provided, wherein, in that case, too, the pressure cylinder is configured as a pressure booster, that is, in the case of each air chamber and associated liquid chamber, the liquid action surface is smaller than the air action surface facing toward same, such that the liquid pressure is higher than the charge pressure.

Thus, in the first and the second embodiment according to a concept of the disclosure, provision is made whereby the air chamber 222 has at least one air chamber port 223 configured to admit compressed air DL with a charge pressure PL for filling the air chamber 222, wherein, when the air chamber 222 is filled with the air quantity ML, the charge pressure PL acts on an air action surface ASL, facing toward the air chamber 222, of the separator 226 in order to generate a displacement force FV, wherein the displacement force FV acts on a liquid action surface ASF, facing toward the liquid chamber 224, of the separator 226 in order to generate a liquid pressure PF of the cleaning liquid F that is received in the liquid chamber 224, and
the pressure cylinder 220 is configured as a pressure booster, wherein the liquid action surface ASF is smaller than the air action surface ASL facing toward same, such that the liquid pressure PF is higher than the charge pressure PL.

The pressure cylinder 220′ correspondingly has an air chamber segment 220.1 for forming a first air chamber 222.1 and a second air chamber 222.2 that is separated in fluid-tight fashion from the first air chamber via the air plunger 231. The pressure cylinder 220′ furthermore has a liquid chamber segment 220.2 for forming a first liquid chamber 224.1 and has a further liquid chamber segment 220.3 for forming a second liquid chamber 224.2. The separator 226 is correspondingly constructed as a symmetrical multiple plunger 229′ with an air plunger 231 arranged in the center and with liquid plungers 233, specifically a first liquid plunger 233.1 and a second liquid plunger 233.2, which are spaced apart in both directions in the direction of the cylinder axis AZ and which are rigidly connected via a plunger shank 235.

The function of an individual cleaning section 100.1, 100.2 is substantially analogous to the cleaning device 100 shown in FIG. 1. However, with the combination of both cleaning sections 100.1, 100.2 in the pressure cylinder 220′, it is advantageously possible to implement alternating pressurization of the first air chamber 222.1, with the first switching valve 270, and of the second air chamber 222.2, with the second switching valve 470. This gives rise, by way of example, to the following sequence:

In a first step, the first switching valve 270 is in an air admission position 270A and the second switching valve 470 is in a ventilation position 470B. The first air chamber 222.1 is pressurized with a first charge pressure PL1, causing a first displacement FV1 to act on the separator 226′ and resulting in an enlargement of the first air chamber 222.1 and thus a decrease in size of the second air chamber 222.2 and of the second liquid chamber 224.2. A second compressed-air cleaning pulse DRI2 with a second pulse pressure PI2 is consequently provided at the second air chamber port 223.2. At the same time, a second liquid cleaning pulse FRI2 with a second liquid pressure PF2 is provided at the second liquid port 225.2 of the second liquid chamber 224.2. The second liquid pressure PF2 is increased in accordance with the pressure booster concept discussed in FIG. 1 and in this case in accordance with the area ratio of the first air action surface ASL1 with respect to the second liquid action surface ASF2.

In a second step, the first switching valve 270 is in a ventilation position 270B and the second switching valve 470 is in an air admission position 470A. It is now correspondingly the case that no first charge pressure PL1 acts at the first air chamber port 223.1, but a second charge pressure P2 acts at the second air chamber port 223.2. Correspondingly, a second displacement force FV2 acts on the second air action surface ASL2, leading to an axial movement of the separator 226′ in the opposite direction in relation to the first step. Correspondingly, the second air chamber 222.2 increases in size, and so too does the second liquid chamber 224.2 in order to draw in new cleaning liquid F. At the same time, the first air chamber 222.1 and the first liquid chamber 224.1 decrease in size. Consequently, a first compressed-air cleaning pulse DRI1 with a first pulse pressure PI1 is provided at the first air chamber port 223.1. At the same time, a first liquid cleaning pulse FRI1 with a first liquid pressure PF1 is provided at the first liquid port 225.1 of the first liquid chamber 224.1. Here, the first liquid pressure PF1 is increased in accordance with the area ratio of the second air action surface ASL2 with respect to the first liquid action surface ASF1.

In embodiments, the pressure cylinder 220′ may be configured without a restoring spring 228. In such embodiments, owing to identical air action surfaces ASL1, ASL2, the first pulse pressure PI1 of the first compressed-air cleaning pulse DRI1 corresponds to the second charge pressure PL2, if a restoring spring 228 is disregarded. Likewise, owing to identical air action surfaces ASL1, ASL2, the second pulse pressure PI2 corresponds to the first charge pressure PL1. In this way, it is advantageously possible for the pulse pressure PI1, PI2 of one cleaning section 100.1, 100.2 to be set by the charge pressure PL1, PL2 of the respective other cleaning section 100.1, 100.2.

In other embodiments, the pressure cylinder 220′ may have at least one restoring spring 228, in particular a first restoring spring 228.1 and a second restoring spring 228.2. In particular, the two restoring springs 228.1, 228.2 may be of identical configuration, in particular identical dimensions, which in the case of a symmetrical separator 226′ and a symmetrical pressure cylinder 222′ has the effect that a rest position of the separator 226′ is situated in the axial center of the pressure cylinder 220′. A deflection of the separator 226′ thus results in a first restoring force FR1, which acts counter to the second displacement force FV2, or a second restoring force FR2, which acts counter to the first displacement force FV1.

The cleaning device 100′ thus advantageously provides a first cleaning section 100.1 and a second cleaning section 100.2 using only one pressure cylinder 220′. The first cleaning section 100.1 is controllable substantially via a first switching valve 270, and the second cleaning section 100.2 is controllable via a second switching valve 470. The other constituent parts already shown in and discussed with regard to FIG. 1 are shown in FIG. 2 for each of the two cleaning sections 100.1, 100.2 using the same reference designations as in FIG. 1, but with a corresponding numeral 1 or 2 to assign them to the respective cleaning section 100.1, 100.2. The effective air chamber volumes VL0 of the first and second air chambers 222.1, 222.2 and the effective liquid chamber volumes VF0 of the first and second liquid chambers 224.1, 224.2, and the action surfaces ASF1, ASF2, ASL1, ASL2, correspond in particular to those mentioned with regard to FIG. 1.

One or both cleaning sections 100.1, 100.2 may have a bypass valve arrangement 330.1, 330.2 analogous to that shown in FIG. 1. One or both cleaning sections 100.1, 100.2 may have a charge pressure setter 360.1, 360.2 analogous to that shown in FIG. 1.

The compressed-air cleaning pulses DRI1, DRI2 are provided at a first and a second compressed-air nozzle port 104.1, 104.2, and the liquid cleaning pulses FRI1, FRI2 are provided at a first and a second liquid nozzle port 102.1, 102.2. These compressed-air and liquid nozzle ports 102.1, 102.2, 104.1, 104.2 may be assigned to one or more cleaning nozzles 320 (not shown here). In particular, they may be assigned to one cleaning nozzle 320 for cleaning a relatively large sensor surface 300.

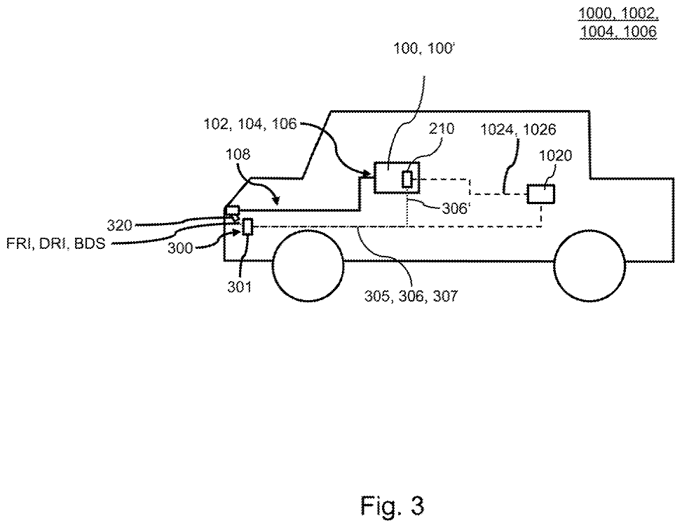

FIG. 3 is a schematic illustration of a vehicle 1000, in particular a passenger motor vehicle 1002 or a utility vehicle 1004 or a trailer 1006, in the present case in the form of an autonomous or partially autonomous vehicle, having a cleaning device 100, 100′ for at least one cleaning nozzle 320 for cleaning a sensor surface 300 of a sensor 301 configured as an optical sensor, for example as a camera. The cleaning device 100 may however be used in other vehicles.

The cleaning device 100, 100′ may have a module control unit 210 that is connected in a signal-conducting manner to a vehicle control unit 1020 via a vehicle control line 1024. The vehicle control line 1024 is in particular configured as a vehicle bus 1026, in particular CAN bus. In other embodiments, for the control of the cleaning device 100, 100′, the cleaning device 100, 100′, in particular the at least one switching valve 270, 470 and/or the at least one bypass valve 330, 330.1, 330.2 and/or the at least one charge pressure setter 360, 360.1, 360.2, may be connected in signal-conducting fashion to a vehicle control unit 1020 of the vehicle 1000. In particular, one or more cleaning devices 100, 100′ may be arranged centrally in one region of the vehicle 1000, in particular adjacently to one another or as a central module. Alternatively or in addition, multiple cleaning devices 100, 100′ may be arranged peripherally in the vehicle 1000, in particular in each case in the vicinity of the cleaning nozzle 320 which a supply is to be provided.

The sensor 301 is connected in signal-conducting fashion to the vehicle control unit 1020, for the transmission of sensor signals 305, via a sensor line 306. In particular, a cleaning check signal 307 for establishing whether the sensor surface 300 has been cleaned or whether a liquid cleaning pulse FRI has been dispensed may be transmitted to the vehicle control unit 1020 via the sensor line 306. In the case of a sensor 301 configured as a camera, a cleaning check signal 307 may be generated in particular using image processing means, for example by detection of an improvement in the signal quality of the sensor signal or detection of liquid particles in the camera image. In embodiments, it is alternatively or additionally possible for a sensor line 306′ to be provided between the sensor 301 and the module control unit 210, in particular for the purposes of transmitting the cleaning check signal 307.

The cleaning nozzle 320 is configured to apply a liquid cleaning pulse FRI and/or a compressed-air cleaning pulse and/or a bypass compressed-air flow to the sensor surface 300. The cleaning nozzle 320 is in particular connected in fluid-conducting fashion to the cleaning device 100 via a nozzle liquid port 102 and/or a nozzle compressed-air 104 and/or a nozzle combination port 106. In embodiments in which the cleaning nozzle 320 is not arranged directly at the cleaning device 100 or the sensor cleaning module 200, the cleaning nozzle 320 may be connected in fluid-conducting fashion to the nozzle liquid port 102 and/or to the nozzle compressed-air port 104 and/or to the nozzle combination port 106 via a nozzle connection line 108.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS (PART OF THE DESCRIPTION)

100, 100′ Cleaning device
100.1, 100.2 First, second cleaning section
102 Liquid nozzle port
102.1, 102.2 First, second liquid nozzle port
104 Compressed-air nozzle port
104.1, 104.2 First, second compressed-air nozzle port
106 Nozzle combination port
108 Nozzle connection line
210 Module control unit
220, 220′ Pressure cylinder
220.1 Air chamber segment of the pressure cylinder
220.2 Liquid chamber segment of the pressure cylinder
220.3 Further liquid chamber segment of the pressure cylinder
221 Cylinder internal wall
222 Air chamber
222.1, 222.2 First, second air chamber
223 Air chamber port
223.1, 223.2 First, second air chamber port
224 Liquid chamber
224.1, 224.2 First, second liquid chamber
225 Liquid chamber port
225.1, 225.2 First, second liquid chamber port
226, 226′, Separator
226.1, 226.2 First, second separator
227 Air chamber line
228 Restoring spring
228.1, 228.2 First, second restoring spring
229, 229′ Multiple plunger
231 Air plunger
233 Liquid plunger
233.1, 233.2 First, second liquid plunger
235 Plunger shank
237 Air plunger sealing ring
239 Liquid plunger sealing ring
241 Piston shank sealing ring
270 Switching valve, first switching valve
270.1, 270.2, 270.3 First to third ports of the switching valve
270A Air admission position of the switching valve
270B Ventilation position of the switching valve
272 Module compressed-air port
273 Compressed-air nozzle connection line
278 Compressed-air nozzle line
300 Sensor surface
301 Sensor
305 Sensor signal
306, 306′ Sensor line
307 Cleaning check signal
320 Cleaning nozzle
330 Bypass valve arrangement
330.1, 330.2 First, second bypass valve arrangement
332 2/2 directional valve
332.1, 332.2 First, second port of the 2/2 directional valve
332A Closed position of the 2/2 directional valve
332B Open position of the 2/2 directional valve
333 2/2 directional solenoid valve
350 Intake pressure check valve
350.1, 350.2 First, second intake pressure check valve
352 Liquid pulse check valve
352.1, 352.2 First, second liquid pulse check valve
354 Compressed-air pulse check valve
360.1, 360.2 First, second charge pressure setter
360 Charge pressure setter
362 Pressure control valve
364 Proportional valve
400 Liquid source
470 Second switching valve
470A Air admission position of the second switching valve
470B Ventilation position of the second switching valve
600 Pressure source, compressed-air source
604 Pressure accumulator
618 Module liquid port
619 Cylinder connection point
619.1, 619.2 First, second cylinder connection point
621 Bypass connection point
623 Bypass line
626 Liquid nozzle line
1000 Vehicle
1002 Passenger motor vehicle
1004 Utility vehicle
1006 Trailer
1020 Vehicle control unit
1024 Vehicle control line
1026 Vehicle bus
ASF Liquid action surface
ASF1, ASF2 First, second liquid action surface
ASL Air action surface
ASL1, ASL2 First, second air action surface
AZ Cylinder axis
BDS Bypass compressed-air flow
DF Liquid plunger diameter
DL Compressed air
DLU Air plunger diameter
DRI Compressed-air cleaning pulse
DRI1, DRI2 First, second compressed-air cleaning pulse
F Cleaning liquid
FR Restoring force
FRI Liquid cleaning pulse
FRI1, FRI2 First, second liquid cleaning pulse
FV Displacement force
H Stroke
K Spring constant
MF Liquid quantity
MF1, MF2 First, second liquid quantity
ML Air quantity
ML1, ML2 First, second air quantity
PF Liquid pressure
PF1, PF2 First, second liquid pressure
PI Pulse pressure
PI1, PI2 First, second pulse pressure
PL Charge pressure
PL1, PL2 First, second charge pressure
VF Liquid chamber volume
VF0 Effective liquid chamber volume
VF1 First liquid chamber volume
VF2 Second liquid chamber volume
VL Air chamber volume
VL0 Effective air chamber volume
VL1 First air chamber volume
VL2 Second air chamber volume
VT Dead volume
VZ Cylinder volume

1. A cleaning device for a vehicle for providing at least one of a liquid cleaning pulse and a compressed-air cleaning pulse for at least one cleaning nozzle, the cleaning device comprising:
a pressure cylinder defining a cylinder volume and having a movable separator that divides said cylinder volume in fluid-tight fashion into a first air chamber configured to receive an air quantity and a second liquid chamber configured to receive a liquid quantity of a cleaning liquid;
said separator being movable axially along a cylinder axis and bearing sealingly against a cylinder internal wall of said pressure cylinder;
said first air chamber having at least one air chamber port configured to admit compressed air with a charge pressure for filling said first air chamber;
wherein, when said first air chamber is filled with the air quantity, the charge pressure acts on an air action surface, facing toward said first air chamber, of said separator to generate a displacement force;
wherein said displacement force acts on a liquid action surface, facing toward said liquid chamber, of said separator to generate a liquid pressure of the cleaning liquid that is received in said liquid chamber;
said pressure cylinder is configured as a pressure booster; and,
wherein said liquid action surface is smaller than said air action surface facing toward said air chamber, such that the liquid pressure is higher than the charge pressure.

2. The cleaning device of claim 1 further comprising a restoring spring; and, said separator being held in said pressure cylinder via said restoring spring for generating a restoring force that acts counter to the displacement force.

3. The cleaning device of claim 1 further comprising a restoring spring; and, said separator being held in said pressure cylinder via said restoring spring for generating a restoring force that acts counter to the displacement force when said separator is moved while the air chamber is being filled.

4. The cleaning device of claim 1, wherein:
said separator has a first air action surface and a second air action surface arranged opposite said first air action surface in a direction of said cylinder axis;
said separator has a first liquid action surface arranged opposite said first air action surface in the direction of the cylinder axis;
said separator has a second liquid action surface arranged opposite said second air action surface in the direction of the cylinder axis;
said first air action surface faces toward said first air chamber;
said second air action surface faces toward a second air chamber;
said first liquid action surface faces toward said first liquid chamber; and,
said second liquid action surface faces toward said second liquid chamber.

5. The cleaning device of claim 1 further comprising a switching valve configured to produce a pneumatic connection between a module compressed-air port and said at least one air chamber port when in an air admission position.

6. The cleaning device of claim 1 further comprising a switching valve configured to produce a pneumatic connection between a module compressed-air port and said at least one air chamber port when in an air admission position and to produce a pneumatic connection between said air chamber port and a compressed-air nozzle line when in a ventilation position.

7. The cleaning device of claim 5 further comprising a bypass valve arrangement configured to produce a pneumatic connection between said module compressed-air port and the compressed-air nozzle line bypassing said switching valve, when in an open position in order to provide a bypass compressed-air flow.

8. The cleaning device of claim 1, wherein at least one of said pressure cylinder and said separator are configured such that said first air chamber has a dead volume through which said separator does not pass; wherein said at least one air chamber port is arranged in a region of the dead volume.

9. The cleaning device of claim 8, wherein said dead volume has an axial extent of less than 5 millimeters.

10. The cleaning device of claim 8, wherein said dead volume has an axial extent of less than 2 millimeters.

11. The cleaning device of claim 1, wherein said separator is configured as a multiple plunger including at least one air plunger and at least one liquid plunger having at least one liquid action surface; and, said at least one air plunger has at least one air action surface connected via a plunger shank to said at least one liquid plunger.

12. The cleaning device of claim 1 further comprising a charge pressure setter.

13. The cleaning device of claim 12, wherein said pressure setter is at least one of a pressure control valve and a proportional valve.

14. The cleaning device of claim 12, wherein the charge pressure setter is arranged in a compressed-air connection line.

15. The cleaning device of claim 1 further comprising at least one cleaning nozzle arranged and configured to apply said at least one of the liquid cleaning pulse and the compressed-air cleaning pulse to at least one sensor surface.

16. A vehicle comprising:
at least one cleaning device configured to provide at least one of a liquid cleaning pulse and a compressed-air cleaning pulse for at least one cleaning nozzle;
said at least one cleaning device including a pressure cylinder defining a cylinder volume;
said pressure cylinder having a movable separator that divides said cylinder volume in fluid-tight fashion into an air chamber configured to receive an air quantity and a liquid chamber configured to receive a liquid quantity of a cleaning liquid;
said separator being movable axially along a cylinder axis and bearing sealingly against a cylinder internal wall of said pressure cylinder;
said air chamber having at least one air chamber port configured to admit compressed air with a charge pressure for filling said air chamber;
wherein, when said air chamber is filled with the air quantity, the charge pressure acts on an air action surface, facing toward said air chamber, of said separator to generate a displacement force;
wherein said displacement force acts on a liquid action surface, facing toward said liquid chamber, of said separator to generate a liquid pressure of the cleaning liquid that is received in said liquid chamber;
said pressure cylinder is configured as a pressure booster; and,
wherein said liquid action surface is smaller than said air action surface facing toward said air chamber, such that the liquid pressure is higher than the charge pressure.

17. The vehicle of claim 16, wherein the vehicle is a passenger motor vehicle, a utility vehicle, or a trailer.
